(19) United States
(12) Patent Application Publication
(10) Pub. No.: US 2015/0347764 A1
(43) Pub. Date: Dec. 3, 2015

(54) METHODS AND SYSTEMS FOR MODIFYING PARENTAL CONTROL PREFERENCES BASED ON BIOMETRIC STATES OF A PARENT

(71) Applicant: UNITED VIDEO PROPERTIES, INC., SANTA CLARA, CA (US)

(72) Inventors: James Cornell, Chicago, IL (US); Andrew Fundament, Arlington Heights, IL (US); Melissa Bradley, Mt. Prospect, IL (US); Vanessa Wickenkamp, Elmhurst, IL (US); Andy Dustin, Palos Hills, IL (US)

(73) Assignee: UNITED VIDEO PROPERTIES, INC., SANTA CLARA, CA (US)

(21) Appl. No.: 14/291,472

(22) Filed: May 30, 2014

(51) Int. Cl. G06F 21/60; G06F 21/62

(52) U.S. Cl. CPC G06F 21/604; G06F 21/6218

(57) ABSTRACT

Methods and systems are described herein for a media guidance application that modifies parental control preferences based on the biometric state of a first user (e.g., a parent) and whether or not a change of the biometric state of the first user is caused by a second user (e.g., a child) that is subject to the parental control preferences.

### BACKGROUND

In conventional systems, users have access to a plethora of media content. However, not all content is suitable for all users. Accordingly, many systems include techniques for restricting access to media content based on predetermined criteria. While effective in restricting access to the media content meeting that criteria, such techniques often require users to perform manual tasks such as entering passwords in order to remove the restrictions. Moreover, as the criteria for what content is restricted (or not restricted) may constantly change, users may find themselves constantly updating the predetermined criteria.

### SUMMARY

Accordingly, methods and systems are described herein for a media guidance application that modifies parental control preferences based on the biometric state of a first user (e.g., a parent) and whether or not a change of the biometric state of the first user is caused by a second user (e.g., a child) that is subject to the parental control preferences. For example, the media guidance application may modify parental control preferences based on the biometric states of a parent. For example, a first user (e.g., a parent) may be more lenient with regard to what media content a second user (e.g., a child) is allowed to access when the first user is in a good mood as compared to when the first user is in a bad mood. In another example, a first user (e.g., a parent) may relax the length of time that a second user (e.g., a child) is allowed to use a device (e.g., watch television) if the first user is tired and does not wish to entertain the second user. The media guidance application may detect these different biometric states of the first user and automatically adjust content control preferences accordingly.

Furthermore, the media guidance application may use information about the biometric state of the user (e.g., an event that caused the user to have the current biometric state) to further target the content control preferences. For example, the media guidance application may determine that the current biometric state (e.g., corresponding to an angry emotional state) of the first user (e.g., a parent) is the result of a particular user (e.g., a child). Therefore, the first user may wish to punish the second user by increasing the content that is restricted by the content control preferences. Alternatively, the media guidance application may determine that the current biometric state of the first user is not the result of the particular user. Therefore, the first user may not wish for his or her current biometric state to affect the content control preferences associated with the second user. For example, while a parent that is upset because a child failed a school exam may wish to impose restrictive content control preferences on the child, a parent that is upset because the stock market fell ten percent may not wish to impose restrictive content control preferences on the child.

In some aspects, a media guidance application may store first content control preferences for a first user associated with a baseline biometric state of the first user. For example, during times of “normal” or a baseline biometric state of the user, the user may have a first content control preferences (e.g., preferences associated with one or more users). Each of these preferences may be stored (e.g., in a user profile) or may be maintained on one or more devices as a default content control preference.

The media guidance application may determine a current biometric state of the first user is inconsistent with the baseline biometric state of the first user. For example, the media guidance application may incorporate, or have access to, a detection module that can monitor the biometric state of a user and detect any variations in the biometric state of a user. For example, in response to detecting that a current biometric state of a user is outside a threshold variance of the baseline biometric state, the media guidance application may determine the current biometric state of the user is inconsistent with baseline biometric state of the user. Additionally, the media guidance application may determine whether the current biometric state of the user corresponds to a biometric state that affects first content control preferences.

In response to detecting the inconsistency, the media guidance application may determine whether the inconsistency is due to a second user that is subject to the content control preferences by identifying an event that caused the current biometric state of the user. For example, to further target the content control preferences the media guidance application may determine the cause of the inconsistent biometric state. The media guidance application may also determine if a user (e.g., a child) subject to the content control preferences is the cause of the inconsistent biometric state.

In response to determining that the inconsistency is due to the second user, the media guidance application may select second content control preferences that are based on the current biometric state of the first user. For example, in response to determining that a user that is subject to the content control preferences is the cause of the inconsistent biometric state, the media guidance application may modify the content control preferences. To determine the particular content controls preferences to apply, the media guidance application may cross-reference the current biometric state of the user in a database listing the content control preferences associated with every biometric state of the user.

In some embodiments, the media guidance application may identify the event based on information posted on a server within a threshold period of time of the current biometric state of the first user. For example, in response to detecting the inconsistent biometric state of the user, the media guidance application may retrieve information posted by the user and/or any other source in an attempt to determine a possible cause of the inconsistent biometric state. For example, if mainstream media sources are reporting a terrorist attack recently occurred and the current biometric state of the user corresponds to a scared emotional state, the media guidance application may determine that the current biometric state of the user is due to the terrorist attack. In another example, if a user recently posted that he or she has an exam today and the current biometric state of the user corresponds to an anxious emotional state, the media guidance application may determine that the current biometric state of the user is due to the exam. Accordingly, the media guidance application may analyze the information for an indication of a causal relationship between the current biometric state of the user and the second user.

In some embodiments, the media guidance application may apply the content control preferences to one or more devices. For example, the media guidance application may apply the content control preferences to a group of devices (e.g., all the devices within a home) or the media guidance application may select a particular device or set of devices associated with the second user (e.g., a smartphone carried by the second user). Accordingly, the media guidance application may target the content control preferences to particular devices so as to not disrupt the use of other devices by other users. In some embodiments, the media guidance application may transmit messages and/or notifications to the effected devices indicating the changes and/or the event upon which the changes are based to the content control preferences that have occurred.

In some embodiments, the media guidance application may maintain the content control preferences until the first user modifies them. Alternatively or additionally, the media guidance application may automatically adjust the content control preferences in response to determining that the current biometric state of the user has changed. For example, in response to determining that a first user (e.g., a parent) is no longer angry or tired, the media guidance application may revert to default content control preferences.

It should be noted that the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a display screen for use in performing media guidance application operations in accordance with some embodiments of the disclosure;

FIG. 2 shows another illustrative example of a display screen used to interact with content control preferences in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is a flowchart of illustrative steps for selecting second content control preferences that are based on the current biometric state of the first user in accordance with some embodiments of the disclosure; and

FIG. 6 is a flowchart of illustrative steps for determining content control preferences changes based on the current biometric state of the user associated with an event in accordance with some embodiments of the disclosure.

### DETAILED DESCRIPTION OF THE DRAWINGS

Methods and systems are described herein for a media guidance application that modifies parental control preferences based on the biometric state of a first user (e.g., a parent) and whether or not a change of the biometric state of the first user is caused by a second user (e.g., a child) that is subject to the parental control preferences. As referred to herein, a “media guidance application,” an “interactive media guidance application,” or, sometimes, a “guidance application” is an interface that allows users to efficiently navigate content selections, easily identify content that they may desire, and/or perform media guidance application operations.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory, including, but not limited to, volatile and non-volatile computer memory or storage devices such as a hard disk, floppy disk, USB drive, DVD, CD, media cards, register memory, processor caches, Random Access Memory (“RAM”), etc.

As referred to herein, a “media guidance application operation” refers to any operation corresponding to providing, receiving, and/or generating media guidance data for consumption by a user. For example, media guidance application operations include displaying media guidance data, providing options to navigate, select, and edit media guidance data or content (e.g., a media asset) associated with media guidance data, and/or manipulating a device used to access (e.g., a display device), retrieve (e.g., a server), and/or associate media guidance data with a user (e.g., a user device for monitoring brain activity).

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

Other operations of a media guidance application are to play media assets and provide fast access playback operations for those media assets. As referred to herein, the phrase “fast-access playback operations” should be understood to mean any media guidance application operation that pertains to playing back a non-linear media asset faster than normal playback speed or in a different order than the media asset is designed to be played, such as a fast-forward, rewind, skip, chapter selection, segment selection, skip segment, jump segment, next segment, previous segment, skip advertisement or commercial, next chapter, previous chapter or any other operation that does not play back the media asset at normal playback speed. The fast-access playback operation may be any playback operation that is not “play,” where the play operation plays back the media asset at normal playback speed.

Still other operations of media guidance application may include the control of devices used to consume media assets. For example, a media guidance application operation may include turning a device on and off, raising the volume associated with a device, adjusting the display settings of a device, assigning parental controls, transferring information from one device to another, storing and/or recording content, entering authorization information and/or payment information, etc.

In some embodiments, a media guidance application operation may relate to a social media activity such as publicly distributing a media asset and/or receiving information from a social media network. For example, the media guidance application may retrieve a list of friends (e.g., a social network buddy list), contacts (e.g., retrieved from a phone/text message/e-mail account associated with the user), and/or other listings featuring other entities with known associations to the user and distribute the notification and/or media assets to contacts.

As used herein, a “social network” refers to a platform that facilitates networking and/or social relations among people who, for example, share interests, activities, backgrounds, and/or real-life connections. In some cases, social networks may facilitate communication between multiple user devices (e.g., computers, televisions, smartphones, tablets, etc.) associated with different users by exchanging content from one device to another via a social media server. As used herein, a “social media server” refers to a computer server that facilitates a social network. For example, a social media server owned/operated/used by a social media provider may make content (e.g., status updates, microblog posts, images, graphic messages, etc.) associated with a first user accessible to a second user that is within the same social network as the first user. In such cases, classes of entities may correspond to the level of access and/or the amount or type of content associated with a first user that is accessible to a second user.

The media guidance application may further grant access to or restrict access to one or more media guidance applications based on predetermined criteria. As described herein, “parental controls” or “content control preferences” refer to content filters, usage filters, management tools, and/or monitoring features used to grant access to, restrict access to, or track the performance of one or more media guidance application operations to one or more users. For example, content control preferences, described herein, may prohibit a particular user from performing a particular media guidance application operation (e.g., viewing a particular media asset) on a particular device.

In some embodiments, the content control preferences may be based at least in part on a location or time of day. For example, content control preference may vary depending on whether or not a user subject to the content control preferences is at home or whether the day of the week is a weekend or a week day.

In some embodiments, the media guidance application may maintain the content control preferences until the first user modifies them. Alternatively or additionally, the media guidance application may automatically adjust the content control preferences in response to determining that the current biometric state of the user has changed. For example, in response to determining that a first user (e.g., a parent) is no longer angry or tired, the media guidance application may revert to default content control preferences.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

In some embodiments, the media guidance application may apply the content control preferences to one or more devices. For example, the media guidance application may apply the content control preferences to a group of devices (e.g., all the devices within a home) or the media guidance application may select a particular device or set of device associated with the second user (e.g., a smartphone carried by the second user). Accordingly, the media guidance application may target the content control preferences to particular devices as to not disrupt the use of other devices by other users. In some embodiments, the media guidance application may transmit messages and/or notifications to the affected devices indicating the changes and/or the event upon which the changes are based to the content control preferences that have occurred.

In some embodiments, a content control preference may be based on a biometric state of a user. As used herein, a “biometric state” refers to any qualitative or quantitative description of one or more biometric measurements related to a user. For example, a biometric state may describe a particular biometric measurement (e.g., the heart rate (in beats per minute), breath rate (in breaths per minute), blood pressure (in millimeters of mercury), etc.) of a user. A biometric state may alternatively or additionally describe a characteristic of a user relative to a baseline biometric state of the user (e.g., whether or not the user has a current attention level above or below the average attention level of the user) or relative to a baseline biometric state of an average user (e.g., whether or not the perspiration level of the user as measured by skin conductance is higher or lower than an average user in similar circumstances).

The media guidance application may further interpret or express the measurements in numerous techniques such as ratios, percentages, categories (e.g., high, normal, low), or using any other technique for distinguishing one biometric state from another. For example, a quantitative heart rate measurement (e.g., in beats per minute) may be converted into a qualitative reading (e.g., such as “Good” or “Bad”) when generated for display to the user.

As used herein, “a biometric measurement” refers to distinctive, measurable characteristic used to label and describe the psychological or physiological condition of a user. For example, biometric measurements that may be received, managed, monitored, and/or shared by a media guidance application may include psychological characteristics related to the level of concentration, emotional state, mood, and/or pattern of behavior of a person, including but not limited to typing rhythm, gait, frequency of social interactions, voice tones, etc., or may include physiological characteristics related to the status and/or shape of the body such as height, weight, medical condition(s), heart rate, blood pressure, fingerprint, body mass index, glucose level, face description, DNA, palm print, hand geometry, iris recognition, retina, odor/scent, and/or any other mechanical, physical, and biochemical functions of a user, his/her organs, and the cells of which they are composed.

In some embodiments, the media guidance application may determine a psychological or physiological condition of a user based on one or more biometric measurements. For example, the media guidance application may determine the current mood of a user based on the heart rate, drowsiness level, or current brain activity of the user. In another example, the media guidance application may determine the level of attention of a user based on current brain activity, eye contact, etc. Systems and methods for determining moods, levels of attention, and other characteristics of a user based on brain activity are discussed in greater detail in connection with Klappert et al., U.S. patent application Ser. No. 14/038,158, filed Sep. 26, 2013; Klappert et al., U.S. patent application Ser. No. 14/038,046, filed Sep. 26, 2013; Klappert et al., U.S. patent application Ser. No. 14/038,171, filed Sep. 26, 2013; Klappert et al., U.S. patent application Ser. No. 14/038,257, filed Sep. 26, 2013; Klappert et al., U.S. patent application Ser. No. 14/037,984, filed Sep. 26, 2013; and Klappert et al., U.S. patent application Ser. No. 14/038,044, filed Sep. 26, 2013, which are hereby incorporated by reference herein in their entireties.

It should be noted that any embodiment associated with the receipt, management, monitoring, and/or sharing of one or more biometric measurements (or biometric state) may also be applied to the receipt, management, monitoring, and/or sharing of any other biometric measurement (or biometric state).

In some embodiments, information related to biometric measurements and/or psychological or physiological conditions of a user, including any settings associated with the receipt, management, monitoring, and/or sharing of one or more biometric measurements and/or psychological or physiological conditions of the user may be stored in a user profile. User profiles may also include compilations of media content interests of the user.

In some embodiments, the biometric state of the user involves receiving data from a device attached to the user. For example, the biometric monitoring device may be a device worn or held by a user such as an armband, wristband, eyeglasses, or other wearable electronic device. Alternatively or additionally, the media guidance application may monitor biometric states of a user using a detection module incorporated into or accessible by the media guidance application, or a device upon which the media guidance application is implemented.

In some embodiments, a media guidance application may store first content control preferences for a first user associated with a baseline biometric state of the first user. For example, during times of “normal” or a baseline biometric state of the user, the user may have first content control preferences (e.g., preferences associated with one or more users). Each of these preferences may be stored (e.g., in a user profile) or may be maintained on one or more devices as a default content control preference.

The media guidance application may determine a current biometric state of the first user is inconsistent with the baseline biometric state of the first user. For example, the media guidance application may detect any variations in the biometric state of a user. As referred to herein, a first biometric state is inconsistent with a second biometric state when the biometric measurements of the first biometric state do not correspond to the biometric measurements of the second biometric state. In some embodiments, a threshold range of biometric measurements associated with a particular biometric may account for any transient variations in a biometric state. For example, a threshold range of a biometric state may be defined as an average biometric measurement over a particular period of time. In addition, a threshold range for a biometric state may refer to a composite range that includes one or more biometric measurements that describe the biometric state.

For example, in response to detecting that a current biometric state of a user includes one or more biometric measurements that are outside a threshold variance of one or more biometric measurements of the baseline biometric state, the media guidance application may determine the current biometric state of the user is inconsistent with the baseline biometric state of the user.

In response to detecting the inconsistency, the media guidance application may determine whether the inconsistency is due to a second user that is subject to the content control preferences by identifying an event that caused the current biometric state of the user. For example, to further target the content control preferences the media guidance application may determine the cause of the inconsistent biometric state. The media guidance application may also determine if a user (e.g., a child) subject to the content control preferences is the cause of the inconsistent biometric state.

In some embodiments, the media guidance application may identify the event based on information posted on a server (e.g., a social network server) within a threshold period of time of the current biometric state of the first user. For example, in response to detecting the inconsistent biometric state of the user, the media guidance application may retrieve information posted by the user and/or any other source in an attempt to determine a possible cause of the inconsistent biometric state. For example, if mainstream media sources are reporting a favorite sports team of a user (e.g., as indicated in a user profile) has recently won a game and the current biometric state of the user corresponds to a happy emotional state, the media guidance application may determine that the current biometric state of the user is due to the sports team winning the game. In another example, if a second user recently posted (e.g., on the second user's social network website) that he or she failed an exam today and the current biometric state of the first user (e.g., determined by a user profile to be a parent of the second user) corresponds to an angry emotional state, the media guidance application may determine that the current biometric state of the first user is due to the second user failing the exam.

Accordingly, the media guidance application may analyze the information for an indication of a causal relationship between the current biometric state of the first user and the second user. For example, in addition to determining whether or not an event occurred within a threshold time period of the current biometric state of the user, the media guidance application may determine the subject matter of the event, the participants in the event, the location of the event, and/or any other content or context associated with the event. The media guidance application may then retrieve various information about the first user (e.g., from a user profile) to determine whether any of the information about the user indicates that the event may affect the biometric state of the user.

As referred to herein, an “event” refers to an occurrence or situation that bears on the biometric state of a user. In some embodiments, information about an event (e.g., details about who was involved in the event, what was involved in the event, where was the event, when was the event, etc.) may be indicated by user-generated content such as messages, calendar entries, postings, status updates, and/or any other content authored by one or more users.

For example, a status update indicating that a user was recently engaged may be used by the media guidance application to determine that the cause of the current biometric state of a user (e.g., a happy emotional state) is due to the recent engagement. In another example, a calendar entry indicating that a user received a date request from another user may be used by the media guidance application to determine that the cause of the current biometric state of the user (e.g., nervousness) is due to the date.

Moreover, the same status update or calendar update may indicate a second user that is associated with causing the current biometric state of the user. For example, the media guidance application may determine whether or not a second user is subject to the content control preferences of the first user by first identifying the second user from the keyword, invites, etc. gleamed from the status update or calendar entry. The media guidance application may then compare the identified person to the list of people subject to the content control preferences of the first user.

For example, the media guidance application may cross-references facts about the event (e.g., who the event involves, what the event involves, etc.) with a database indicating facts about the user to determine if any facts about the event match facts about the user. For example, if an event occurred in Chicago, Ill., and the user lives in Chicago, Ill., the media guidance application may determine that the event may affect the biometric state of the user.

Furthermore, the media guidance application may determine whether the anticipated affect on the biometric state of a user corresponds to the current biometric state of the user. For example, the media guidance application may cross-reference the event with a data base indicating the predicted effect that the event would have on an ordinary person. For example, if an event is a pay increase, the cross-reference may indicate that the current biometric state of an ordinary user that corresponds to such an event would be a happy emotional state. However, if the current biometric state of the user is not associated with a happy emotional state, the media guidance application may determine that the event is not associated with the current biometric state of the user.

In some embodiments, when identifying an event that corresponds to the inconsistent biometric state of the user, the media guidance application may limit its search to a threshold period of time. As used herein, “a threshold period of time,” refers to a finite amount of time with a determined beginning and end point. For example, the media guidance application may compare the time of an inconsistent biometric state of the user (e.g., eight o'clock to nine o'clock) to the time associated with events of the user (e.g., nine o'clock, ten o'clock, ten-thirty, etc.). For example, when attempting to identify an event corresponding to an inconsistent biometric state of the user that occurred, the media guidance application may only process events that occurred within a few days, hours, and/or any other time metric of the inconsistent biometric state of the user. The media guidance application may also consider the chronological order of events relative to the biometric state of the user. For example, in order to identify an event that caused a user to have an inconsistent biometric state, the media guidance application may only search for events occurring before the inconsistent biometric state.

In some embodiments, the media guidance application may determine the likelihood that an event corresponds to an inconsistent biometric state based on the proximity of the event to the inconsistent biometric state. For example, if a first event occurred within a few hours of an inconsistent biometric state, the media guidance application may determine the likelihood that the first event corresponds to the inconsistent biometric state higher than that of a second event that occurred over a month after the inconsistent biometric state.

In some embodiments, the media guidance application may compare the proximity of several inconsistent biometric states to the proximity of one or more events. In addition, the media guidance application may determine similarities between biometric states and/or events. For example, the media guidance application may determine that three inconsistent biometric states are all related (e.g., related to events of the same type). The media guidance application may also determine that a series of three events are all related (e.g., three microblog posts featuring the same keywords). In response the media guidance application may determine if there is a correlation between the proximity of the three inconsistent biometric states and each of the series of events, respectively.

In some embodiments, the threshold period of time may be determined by a user or may be automatically selected by the media guidance application. Furthermore, in some embodiments, the media guidance application may vary the threshold period of time based on the number of occurrences of the inconsistent biometric state, user settings, the length of time of the inconsistent biometric state, prior history of the user related to any inconsistent biometric state, the nature of the inconsistent biometric state, and/or any other factor that may bear on determining the event that corresponds to an inconsistent biometric state.

In some embodiments, the media guidance application may only identify events that are associated with a social network account of a user and/or social sharing of the user. In such cases, the media guidance application may search for events posted on a server in which the server makes the first event accessible to a second user. For example, the server may be a social media server owned/operated/used by a social media provider that makes posting of a first event associated with a first user accessible to a second user that is within the same social network as the first user. In some embodiments, the media guidance application may retrieve a list of other users that are associated with the user based on one or more criteria. For example, the media guidance application may retrieve a list of friends (e.g., a social network buddy list), contacts (e.g., retrieved from a phone or e-mail account associated with the user), and/or other listings featuring other users associated with the user (e.g., in order to determine/identify a second user that is associated with the inconsistent biometric state of the user).

The media guidance application may identify the first event in numerous ways. In some embodiments, the media guidance application may identify the first event in response to determining a threshold number of users, each having corresponding biometric states and corresponding events posted on the server within the threshold period of time of their respective biometric states. For example, if a larger number of people exhibit a similar biometric state near a similar event, the media guidance application may determine that the biometric state is caused by the event. After the media guidance application determines that the first event corresponds to the inconsistency based on cross-referencing the inconsistency in a database associated with events likely to cause inconsistent activities, the media guidance application determines whether the first event corresponds to one of the events likely to cause inconsistent biometric states.

It should be noted that in some embodiments, the media guidance application may use multiple methods for identifying an event associated with an inconsistent activity. For example, in order to reduce false positives (e.g., the identification of events corresponding to inconsistent biometric states that do not actually correspond to inconsistent biometric states), the media guidance application may use a combination of methods to identify events associated with an inconsistent biometric state.

In some embodiments, the media guidance application may use correlations determined between a biometric state and event associated with one user to identify the cause of a biometric state for another user. For example, the media guidance application may determine that the cause of other users having a particular brain state was a particular event. Therefore, the media guidance application may determine that the cause of the current brain state of the user may be the particular event happening to the user.

In response to determining that the inconsistency is due to the second user, the media guidance application may select second content control preferences that are based on the current biometric state of the first user. For example, in response to determining that a user that is subject to the content control preferences is the cause of the inconsistent biometric state, the media guidance application may modify the content control preferences. To determine the particular content controls preferences to apply, the media guidance application may cross-reference the current biometric state of the user in a database listing the content control preferences associated with every biometric state of the user.

The media guidance application may also calibrate and/or perform a training/set-up mode. For example, the media guidance application may receive information from the user, in which the user describes and/or rates current brain states of the user. For example, during calibration, the media guidance application may detect a brain state and ask the user to describe the brain (e.g., designate the state as associated with a particular mood). The current brain state of the user (e.g., the current biometric measurements) will then be designated as corresponding to the particular mood. Additionally or alternatively, the media guidance application may receive instructions designating a particular brain state as corresponding to a particular mood. For example, the media guidance application may retrieve/receive instructions that indicate that brain waves of 8 to 10 Hz indicate that the particular user is in a happy mood.

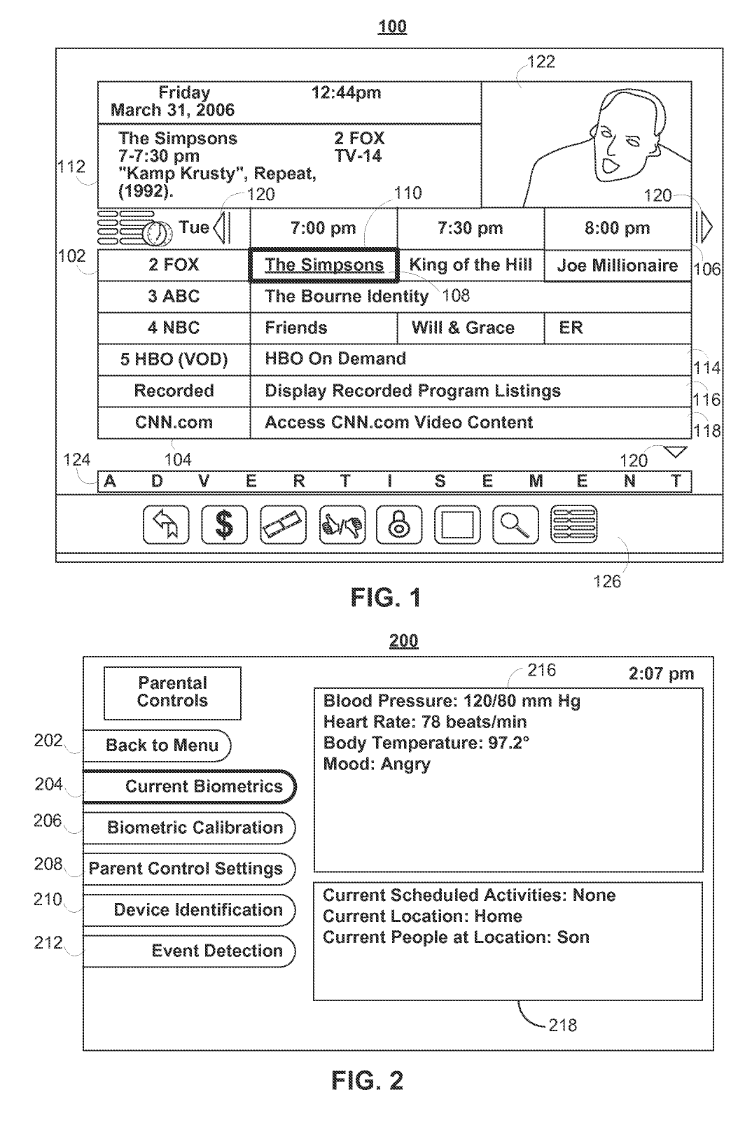

FIGS. 1-2 show illustrative display screens that may be used to access media guidance application operations and/or grant or restrict access to those media guidance application operations. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

FIG. 2 shows another illustrative example of a display screen used to interact with content control preferences. Display 200 includes numerous selectable options associated with select and monitoring content control preferences. For example, display 200 includes selectable options 202 through 212. In addition, display 200 includes window 216, which indicates current biometric measurements and/or biometric states of the user and window 218, which indicates current events and/or information associated with those events that may have a causal relationship to the current biometric state of the user.

Selectable option 202 relates to navigation of a menu in which display 200 is a part. For example, in response to receiving a user selection of selectable option 202, the media guidance application may generate for display a screen featuring media assets, media guidance data, and/or options for performing one or more media guidance application operations.

Selectable option 204 relates to the current biometrics of a user. As selectable option 204 is selected, window 216 currently displays the current biometric states and/or biometric measurements of the user. For example, in response to receiving a user selection of selectable option 204, the media guidance application has generated for display a screen featuring the current blood pressure, heart rate, body temperature, and mood of the user.

Selectable option 206 relates to calibration of the media guidance application and/or the detection module used to monitor the biometric state and/or bio metric measurements of the user. For example, in response to receiving a user selection of selectable option 206, the media guidance application may generate for display a screen featuring a calibration menu or user input questionnaire from which the media guidance application may generate biometric measurements associated with a current biometric state.

Selectable option 208 relates to current content control preferences. For example, in response to receiving a user selection of selectable option 208, the media guidance application may generate for display a screen featuring the various content control preferences and/or the criteria used to determine what content and/or media guidance application operations are available (or not available) to one or more users.

Selectable option 210 relates to device identification settings. For example, in response to receiving a user selection of selectable option 210, the media guidance application may generate for display a screen featuring the various criteria used to determine whether or not a particular device is associated with the content control preferences and/or a particular user.

Selectable option 212 relates to event detection settings. For example, in response to receiving a user selection of selectable option 212, the media guidance application may generate for display a screen featuring the various criteria or techniques for identifying an event and/or a user associated with an event.

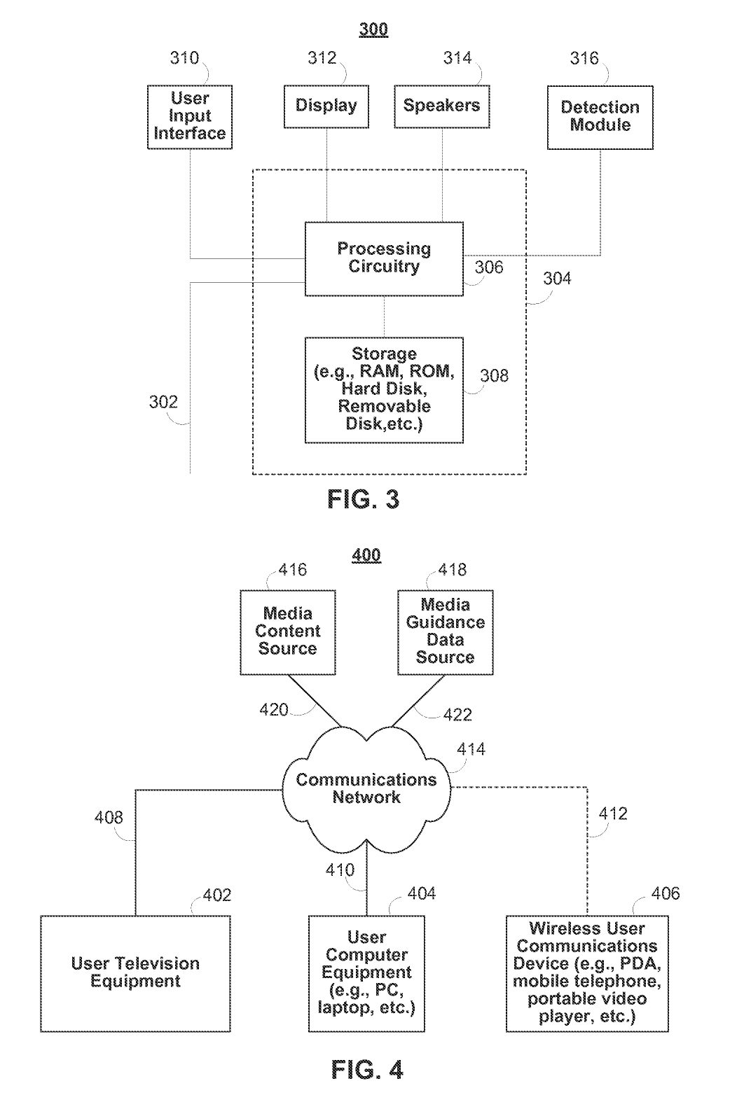

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 312 may be integrated with or combined with display 312. Display 312 may be one or more of a monitor, a television, a liquid crystal display (LCD) for a mobile device, an amorphous silicon display, a low temperature poly silicon display, an electronic ink display, an electrophoretic display, an active matrix display, an electro-wetting display, an electrofluidic display, a cathode ray tube display, a light-emitting diode display, an electroluminescent display, a plasma display panel, a high-performance addressing display, a thin-film transistor display, an organic light-emitting diode display, a surface-conduction electron-emitter display (SED), a laser television, carbon nanotubes, a quantum dot display, an interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

Detection module 316, or the detection module circuitry, may be incorporated into, coupled to, or accessible by the media guidance application (e.g., via control circuitry 304). Detection module 316 may be used to measure, monitor, identify, and determine biometric data and/or a current biometric state of a user. For example, the media guidance application may receive data describing the biometric state of a user.

For example, the media guidance application, or the user device upon which the media guidance application is implemented, may incorporate and/or have access to a plurality of sensors and/or monitoring components. In some embodiments, the media guidance application, or the user device upon which the media guidance application is implemented, may incorporate and/or have access to an electroencephalogram unit (“EEG”). An EEG measures electrical activity associated with a brain of a user. For example, an EEG may measure voltage fluctuations and/or the frequency or frequency range of voltage fluctuations generated by the brain of a user. In some embodiments, the media guidance application, or the user device upon which the media guidance application is implemented, may incorporate and/or have access to an electromyogram unit (“EMG”). An EMG measures the electrical activity of nerves controlling muscles at rest and during contraction.

In some embodiments, the media guidance application, or the user device upon which the media guidance application is implemented, may incorporate and/or have access to a heart monitor, glucose blood meter, respiratory monitors, devices for obtaining tissue, blood, and/or any other suitable samples from a user, and/or any other devices necessary for determining the biometric measurements of the user.

In some embodiments, display 200 may indicate psychological and/or physiological conditions to monitor in addition to, or as an alternative to, individual biometrics to monitor. For example, if the media guidance application monitors a mood of the user, the media guidance application may monitor multiple biometrics in order to monitor the mood. For example, the media guidance application may compare the breathing rate (e.g., determined via a respiratory monitor), blood pressure (e.g., via a blood pressure monitor), alpha wave activity (e.g., via a EKG), and muscle tension (e.g., via an EMG) to determine the particular mood a user is currently experiencing. Thus, in response to selecting to monitor a mood of the user, the media guidance application may obtain data from a plurality of devices and/or obtain a plurality of biometric measurements.

Detection module 316 may also calibrate biometric measurements based on the user. For example, the media guidance application may calibrate the various biometric measurements based on the typical measurement of the user and/or skewing caused by a particular sensor or monitoring component. For example, the media guidance application may track the biometrics of the user (e.g., in a personal log stored in storage 308), which tracks various biometrics of the user.

In some embodiments, detection module 316 may include a Global Positioning System (“GPS”) detection component, which determines or receives information describing the geographic position of a user or an object associated with a user (e.g., a smartphone) for use in determining whether or not to apply content control preferences on the object.

Additionally or alternatively, the media guidance application may determine the biometric state by applying one or more content recognition techniques. For example, detection module 316 may record the biometric state of the user and analyze the biometric state of the user for one or more indicators of a biometric state or a particular biometric measurement. For example, the media guidance application (e.g., via control circuitry 304) may use a content recognition module or algorithm to generate data describing the context, content, and/or any other data necessary for determining a biometric state or a particular biometric measurement. For example, the content recognition module may use object recognition techniques such as edge detection, pattern recognition, including, but not limited to, self-learning systems (e.g., neural networks), optical character recognition, on-line character recognition (including, but not limited to, dynamic character recognition, real-time character recognition, intelligent character recognition), and/or any other suitable technique or method to analyze recorded behavior of a user. For example, the media guidance application may receive data in the form of a video. The video may include a series of frames. For each frame of the video, the media guidance application may use a content recognition module or algorithm to determine the objects (e.g., people, places, things, etc.) in each of the frames or series of frames, which may be used to determine a biometric state or a particular biometric measurement. For example, the media guidance application may analyze each frame of the video to determine the number of times that a user breathes (e.g., by detecting the rise and fall of the chest of a user) over the length of the video. The media guidance application may then compare this determination (e.g., the breath rate of the user) to determine a biometric measurement.

In some embodiments, the content recognition module or algorithm may also include speech recognition techniques, including, but not limited to, Hidden Markov Models, dynamic time warping, and/or neural networks (as described above) to translate spoken words into text and/or processing audio data. The content recognition module may also combine multiple techniques to determine a biometric state or a particular biometric measurement. For example, if the media guidance application determines the user is out of breath or laboring to breathe based on sounds coming from the user, the media guidance application may use this information to determine the current biometric state or a particular biometric measurement of the user.

In addition, the media guidance application may use multiple types of optical character recognition and/or fuzzy logic, for example, when processing keyword(s) retrieved from data (e.g., textual data, translated audio data, user inputs, etc.) describing a biometric state or a particular biometric measurement (or when cross-referencing various types of data in databases). For example, if the particular data received is textual data, using fuzzy logic, the media guidance application (e.g., via a content recognition module or algorithm incorporated into, or accessible by, the media guidance application) may determine two fields and/or values to be identical even though the substance of the data or value (e.g., two different spellings) is not identical.

In some embodiments, the media guidance application may analyze particular received data of a data structure or media asset frame for particular values or text using optical character recognition methods described above in order to determine a characteristic of a media asset. For example, the media guidance application may process the spoken words of the user to find particular keywords that may be indicative of a current biometric state or a particular biometric measurement.

The guidance application may be implemented using any suitable architecture. For example, it may be a stand-alone application wholly implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

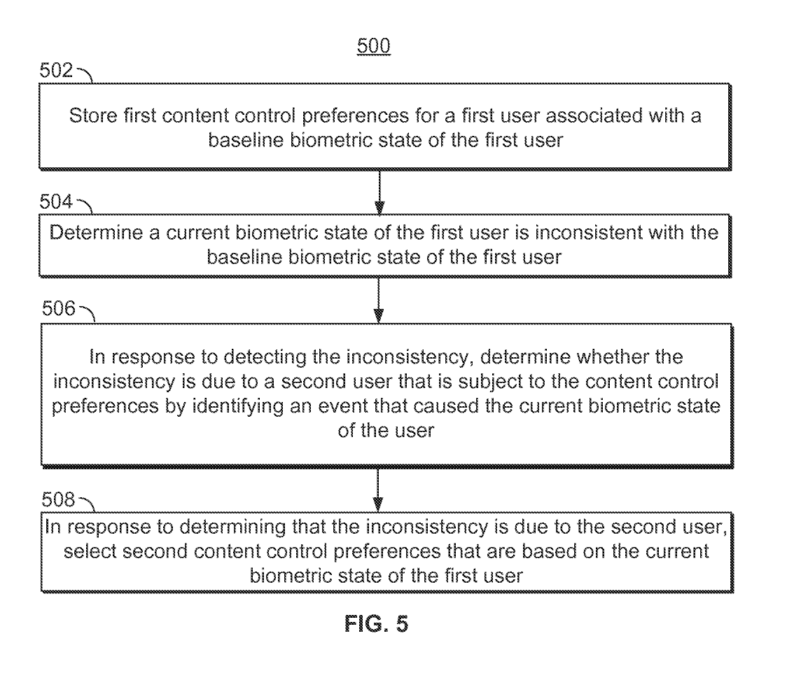

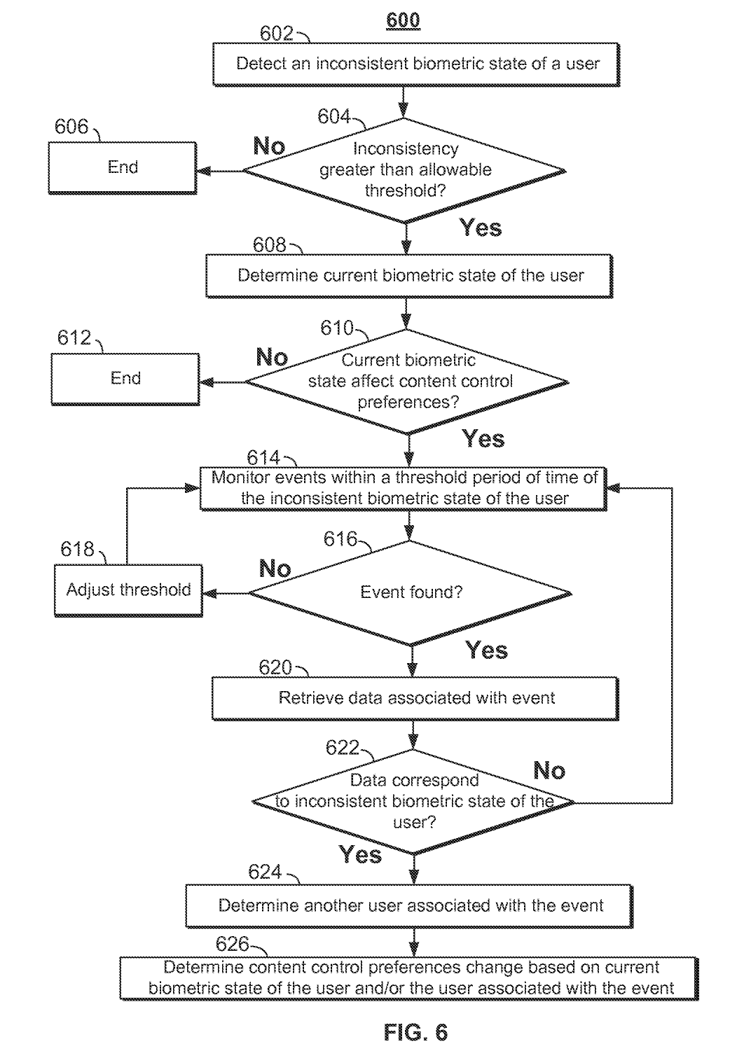

FIG. 5 is a flowchart of illustrative steps for selecting second content control preferences that are based on the current biometric state of the first user. It should be noted that process 500 or any step thereof could be performed on, or provided by, any of the devices shown in FIGS. 3-4. For example, process 500 may be executed by control circuitry 304 (FIG. 3) as instructed by a media guidance application implemented on a user device (e.g., user equipment devices 402, 404, and/or 406 (FIG. 4)) in order to establish communication with a second user based on the biometric state of a first user. In addition, one or more steps of process 500 may be incorporated into or combined with one or more steps of any other process or embodiment (e.g., FIG. 6).

At step 502, the media guidance application stores (e.g., in storage 308 (FIG. 3) and/or in any location accessible via communication network 414 (FIG. 4)) first content control preferences for a first user associated with a baseline biometric state of the first user. For example, the media guidance application may have received a user selection (e.g., via user input interface 310 (FIG. 3)) indicating a desire to use the first content control preferences while the user has a baseline biometric state (e.g., as determined via detection module 316 (FIG. 3) incorporated into or accessible by control circuitry 304 (FIG. 3)). In some embodiments, the media guidance application may receive the content control preference via a parental control interface (e.g., display 200 (FIG. 2)).

In some embodiments, the user may have first content control preferences that are each associated with a different user. For example, a parent may have first content control preferences for each of his or her children. Each of these preferences may be stored (e.g., in a user profile located at storage 308 (FIG. 3) or any location accessible via communications network 414 (FIG. 4)). In some embodiments, the first content control preferences may constitute default content control preferences to which the media guidance application invokes when the media guidance application cannot determine (e.g., using detection module 316 (FIG. 3)) a current biometric state of the user or there are no content control preferences associated with the current biometric state.

At step 504, the media guidance application determines (e.g., via detection module 316 (FIG. 3) incorporated into or accessible by control circuitry 304 (FIG. 3)) that a current biometric state of the first user is inconsistent with the baseline biometric state of the first user. For example, in response to detecting (e.g., via detection module 316 (FIG. 3)) that a current biometric state of a user is outside a threshold variance of the baseline biometric state (e.g., as determined via control circuitry 304 (FIG. 3)), the media guidance application may determine (e.g., via control circuitry 304 (FIG. 3)) the current biometric state of the user is inconsistent with the baseline biometric state of the user. Additionally, the media guidance application may determine (e.g., via control circuitry 304 (FIG. 3)) whether the current biometric state of the user corresponds to a biometric state that affects first content control preferences. For example, if the media guidance application determines (e.g., via control circuitry 304 (FIG. 3)) that the current biometric state of the user is not associated with content control preferences, the media guidance application may maintain the first content control preferences.

At step 506, the media guidance application determines (e.g., via control circuitry 304 (FIG. 3)) whether the inconsistency is due to a second user that is subject to the content control preferences by identifying an event that caused the current biometric state of the user in response to detecting the inconsistency. For example, to further target the content control preferences the media guidance application may determine (e.g., via control circuitry 304 (FIG. 3)) the cause of the inconsistent biometric state. The media guidance application may also determine (e.g., via control circuitry 304 (FIG. 3)) if a user (e.g., a child) subject to the content control preferences is the cause of the inconsistent biometric state.

At step 508, the media guidance application selects (e.g., via control circuitry 304 (FIG. 3)) second content control preferences that are based on the current biometric state of the first user in response to determining that the inconsistency is due to the second user. For example, in response to determining (e.g., via control circuitry 304 (FIG. 3)) that a user that is subject to the content control preferences is the cause of the inconsistent biometric state, the media guidance application may modify (e.g., via control circuitry 304 (FIG. 3)) the content control preferences. To determine the particular content controls preferences to apply, the media guidance application may cross-reference (e.g., via control circuitry 304 (FIG. 3)) the current biometric state of the user in a database (e.g., located locally at storage 308 (FIG. 3) or remotely at any location accessible via communications network 414 (FIG. 4)) listing the content control preferences associated with every biometric state of the user.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 5.

FIG. 6 is a flowchart of illustrative steps for determining content control preference changes based on the current biometric state of the user and the user associated with an event. It should be noted that process 600 or any step thereof could be performed on, or provided by, any of the devices shown in FIGS. 3-4. For example, process 600 may be executed by control circuitry 304 (FIG. 3) as instructed by a media guidance application implemented on a user device (e.g., user equipment devices 402, 404, and/or 406 (FIG. 4)) in order to determine content control preferences changes based on the current biometric state of the user and the user associated with an event that caused the current biometric state of the user. In addition, one or more steps of process 600 may be incorporated into or combined with one or more steps of any other process or embodiment (e.g., process 500 (FIG. 5)).

At step 602, the media guidance application detects an inconsistent biometric state of a user. For example, the media guidance application may incorporate or have access to a detection module (e.g., detection module 316 (FIG. 3)) that may monitor for one or more biometric measurements of a user. For example, the media guidance application may determine (e.g., via control circuitry 304 (FIG. 3)) whether not current biometric measurements of a user corresponds to the biometric measurements associated with a previously identified biometric state.

At step 604, the media guidance application determines (e.g., via control circuitry 304 (FIG. 3)) whether or not the inconsistency detect in step 604 is greater than an allowable threshold. For example, the media guidance application may detect (e.g., via detection module 316 (FIG. 3)) any variations in the biometric state of a user or biometric measurements of the user.

The media guidance application may account for any transient variations in a biometric state or the biometric measurements by allowing for a threshold range of a biometric state or a biometric measurement. For example, in order to more accurately determine (e.g., via control circuitry 304 (FIG. 3)) a biometric state or biometric measurement of a user, the media guidance application may be defined as an average biometric state or biometric measurement over a particular period of time. In such cases, the media guidance application may only detect an inconsistency if the average biometric state or biometric measurement does not correspond to a previously detected biometric state.

If the media guidance application determines (e.g., via control circuitry 304 (FIG. 3)) at step 604 that the inconsistency is not greater than the allowable threshold, the media guidance application proceeds to step 606 and ends. If the media guidance application determines (e.g., via control circuitry 304 (FIG. 3)) at step 604 that the inconsistency is greater than the allowable threshold, the media guidance application proceeds to step 608.

At step 608, the media guidance application determines (e.g., via control circuitry 304 (FIG. 3)) a current biometric state of the user. For example, the media guidance application may cross-reference one or more biometric measurements (e.g., detected via detection module 316 (FIG. 3)) with a database (e.g., stored at storage (308 (FIG. 3) or at any location accessible via communications network 414 (FIG. 4)) listing various biometric states that correspond to different biometric measurements.

For example, the media guidance application may input (e.g., via control circuitry 304 (FIG. 3)) the one or more detected biometric measurements in the database. The database may store ranges for various biometric measurements that correspond to different biometric states. The media guidance application (e.g., via control circuitry 304 (FIG. 3)) may then filter the biometric states to remove the biometric states for which the detected biometric measurements do not fall. The media guidance application (e.g., via control circuitry 304 (FIG. 3)) may then output the one or more biometric states to the user.

In some embodiments, the media guidance application may select a default biometric state, select to default content control preferences, or query the user to identify the current biometric state if the detected biometric measurements do not correspond to a biometric state in the database.

At step 610, the media guidance application determines whether or not the current biometric state affects the content control preferences. For example, in some embodiments a first biometric state may have the same content control preferences as a second biometric state. Alternatively or additionally, the media guidance application may detect multiple biometric states. In such cases, the media guidance application (e.g., via control circuitry 304 (FIG. 3)) may prioritize or combine the content control preferences for the multiple biometric states.

If the media guidance application determines (e.g., via control circuitry 304 (FIG. 3)) that the current biometric state does not affect the content control preferences, the media guidance application proceeds to step 612 and ends. If the media guidance application determines (e.g., via control circuitry 304 (FIG. 3)) that the current biometric state does affect the content control preferences, the media guidance application proceeds to step 614.

At step 614, the media guidance application monitors (e.g., via control circuitry 304 (FIG. 3)) events within a threshold period of time of the inconsistent biometric state. For the media guidance application may identify the event based on information posted on a server (e.g., located at any location accessible via communications network 414 (FIG. 4)) within a threshold period of time of the current biometric state of the first user. For example, the media guidance application (e.g., via control circuitry 304 (FIG. 3)) may compare the time of an inconsistent biometric state of the user (e.g., eight o'clock to nine o'clock) as determined by a clock or calendar function associated with the media guidance application to the time associated with events of the user (e.g., nine o'clock, ten o'clock, ten-thirty, etc.) as determined based on information (e.g., a time of posting, keywords associated with the event, etc.).

For example, when attempting to identify an event corresponding to a current biometric state of the user that occurred, the media guidance application may only process events that occurred within a few days, hours, and/or any other time metric of the current biometric state of the user.

At step 616, the media guidance application determines (e.g., via control circuitry 304 (FIG. 3)) whether or not an event is found during the threshold period of time. For example, in response to detecting the current biometric state of the user, the media guidance application may retrieve information posted by the user and/or any other source in an attempt to determine a possible cause of the current biometric state. For example, if mainstream media sources are reporting a favorite sports team of a user (e.g., as indicated in a user profile) has recently won a game and the current biometric state of the user corresponds to a happy emotional state, the media guidance application may determine (e.g., via control circuitry 304 (FIG. 3)) that the current biometric state of the user is due to the sports team winning the game. In another example, if a second user recently posted (e.g., on the second user's social network website) that he or she failed an exam today and the current biometric state of the first user (e.g., determined by a user profile to be a parent of the second user) corresponds to an angry emotional state, the media guidance application may determine (e.g., via control circuitry 304 (FIG. 3)) that the current biometric state of the first user is due to the second user failing the exam.

If the media guidance application does not find an event at step 616, the media guidance application proceeds to step 618. At step 618, the media guidance application may adjust the threshold period of time before returning to step 614. For example, the media guidance application may expand (e.g., via control circuitry 304 (FIG. 3)) the threshold period of time to include additional events. For example, the media guidance application may also consider the chronological order of events relative to the biometric state of the user. For example, in order to identify an event that caused a user to have a current biometric state, the media guidance application may only search for events occurring within a particular proximity to the inconsistent biometric state. If no events are found, the media guidance application may search for an event occurring with less proximity to the event.

If the media guidance application does find an event at step 616, the media guidance application proceeds to step 620 and retrieves data associated with the event. For example, as discussed above, the media guidance application may identify (e.g., via control circuitry 304 (FIG. 3)) the event that corresponds to the current biometric state in numerous ways. In some embodiments, the media guidance application may identify the event that corresponds to the current biometric state in response to determining a threshold number of users, each having corresponding biometric states associated with corresponding events within the threshold period of time of their respective biometric states. For example, if a larger number of people exhibit a similar biometric state near a similar event, the media guidance application may determine that the biometric state is caused by the event.

The media guidance application may cross-reference (e.g., via control circuitry 304 (FIG. 3)) the retrieved data associated with the detected event with a database (e.g., located at storage 308 (FIG. 3) or any location accessible via communications network 414 (FIG. 4)) that lists types of events that may cause particular biometric states (e.g., such as the current biometric state of the user) at step 622.

The database may store characteristics of the listed types of events. The media guidance application may then compare (e.g., via control circuitry 304 (FIG. 3)) characteristics (e.g., as indicated in the retrieved data) of the detected event (e.g., subject matter, location, time or day, participants, etc.) to the characteristics of one or more of the listed types of events to determine whether or not the characteristics of the detected event match the characteristics of one or more of the listed types of events. If not, the media guidance application may return to step 614. If so, the media guidance application may determine (e.g., via control circuitry 304 (FIG. 3)) that the detected event is the cause of the current biometric state of the user and proceed to step 624.

At step 624, the media guidance application determines (e.g., via control circuitry 304 (FIG. 3)) another user is associated with the event. For example, the data retrieved at step 620 may indicate that a second user is associated with the event. For example, a status update indicating that a first user was recently engaged to the second user may be used by the media guidance application to determine that the cause of the current biometric state of the first user (e.g., a happy emotional state) is due to the recent engagement and the second user is associated with the event. In another example, a calendar entry indicating that a first user received a date request from a second user may be used by the media guidance application to determine that the cause of the current biometric state of the first user (e.g., nervousness) is due to the date and that the second user is associated with the event.

At step 626, the media guidance application determines (e.g., via control circuitry 304 (FIG. 3)) the content control preferences change based on the current biometric state of the user and/or the user associated with the event. For example, the media guidance application may input (e.g., via control circuitry 304 (FIG. 3)) the current biometric state of the user and the identity of the other user associated with the event into a database (e.g., located at storage 308 (FIG. 3) or any location accessible via communications network 414 (FIG. 4)) listing content control preferences associated with various biometric states of a user and users that are subject to the content control preferences. The media guidance application (e.g., via control circuitry 304 (FIG. 3)) may then filter the content control preferences based on whether or not the database listing corresponds to the current biometric state of the user and/or whether or not the second user is subject to the content control preferences.

If the media guidance application determines that a database listing corresponds to the current biometric state of the user and/or the second user is subject to the content control preferences, the media guidance application (e.g., via control circuitry 304 (FIG. 3)) may output the database listing. The database listing may indicate the control preferences that should be applied by the media guidance application.

It should be noted that in some embodiments the media guidance application may skip step 624. For example, the media guidance application may select a content control preference based on the biometric state of the user irrespective of the user associated with the event. For example, the media guidance application may modify content control preferences based on the biometric state of a first user, irrespective of whether or not any other user is the cause of the current biometric state of the user. For example, a first user (e.g., a parent) may be more lenient with regard to what media content a second user (e.g., a child) is allowed to access when the first user is in a good mood as compared to when the first user is in a bad mood. For example, if the first user is already upset, the media guidance application may attempt to minimize activity (e.g., media guidance application operations) that may further upset the user.

In another example, the media guidance application may apply the content control preferences in order to aid the first user (e.g., a parent) that is suffering from a particular biometric state. For example, a first user (e.g., a parent) may relax the length of time that a second user (e.g., a child) is allowed to use a device (e.g., watch television) if the first user is tired and does not wish to entertain the second user. Likewise, a first user (e.g., a parent) may allow a second user (e.g., a child) to use a device (e.g., watch television) if the first user is determined to be sleeping in order to allow the first user to continue to sleep.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 6.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for modifying parental control preferences based on biometric states of a parent, the method comprising:
storing first content control preferences for a first user associated with a baseline biometric state of the first user;
determining a current biometric state of the first user is inconsistent with the baseline biometric state of the first user;
in response to detecting the inconsistency, determining whether the inconsistency is due to a second user that is subject to the content control preferences by identifying an event that caused the current biometric state of the user; and
in response to determining that the inconsistency is due to the second user, selecting second content control preferences that are based on the current biometric state of the first user.

2. The method of claim 1, wherein identifying the event that caused the current biometric state of the first user further comprises identifying the event based on information posted on a server within a threshold period of time of the current biometric state of the first user.

3. The method of claim 2, wherein the information posted on a server indicates a causal relationship between the current biometric state of the user and the second user.

4. The method of claim 1, further comprising cross-referencing the current biometric state of the user with a database to determine the second content control preferences that correspond to the current biometric state of the user.

5. The method of claim 1, further comprising applying the second content control preferences to a user device associated with the second user.

6. The method of claim 1, wherein determining the current biometric state of the first user is inconsistent with the baseline biometric state of the first user further comprises:
determining a variance between the current biometric state of the first user and the baseline biometric state of the first user; and
comparing the variance to a threshold variance.

7. The method of claim 1, wherein the current biometric state of the first user indicates the first user is in a particular mood.

8. The method of claim 1, further comprising notifying the second user that the second content control preferences have been selected based on the event.

9. The method of claim 1, further comprising:
determining that the current biometric state of the first user has become consistent with the baseline biometric state of the first user; and
in response to determining that the current biometric state of the first user has become consistent with the baseline biometric state of the first user, selecting the first content control preferences.

10. The method of claim 1, further comprising in response to determining the current biometric state of the first user is inconsistent with the baseline biometric state of the first user, determining whether the current biometric state of the first user corresponds to a biometric state that affects first content control preferences.

11. A system for modifying parental control preferences based on biometric states of a parent, the system comprising:
storage circuitry configured to store first content control preferences for a first user associated with a baseline biometric state of the first user; and
control circuitry configured to:
determine a current biometric state of the first user is inconsistent with the baseline biometric state of the first user;
in response to detecting the inconsistency, determine whether the inconsistency is due to a second user that is subject to the content control preferences by identifying an event that caused the current biometric state of the user; and
in response to determining that the inconsistency is due to the second user, select second content control preferences that are based on the current biometric state of the first user.

12. The system of claim 11, wherein the control circuitry configured to identify the event that caused the current biometric state of the first user is further configured to identify the event based on information posted on a server within a threshold period of time of the current biometric state of the first user.

13. The system of claim 12, wherein the information posted on a server indicates a causal relationship between the current biometric state of the user and the second user.

14. The system of claim 11, wherein the control circuitry is further configured to cross-reference the current biometric state of the user with a database to determine the second content control preferences that correspond to the current biometric state of the user.

15. The system of claim 11, wherein the control circuitry is further configured to apply the second content control preferences to a user device associated with the second user.

16. The system of claim 11, wherein the control circuitry configured to determine the current biometric state of the first user is inconsistent with the baseline biometric state of the first user is further configured to:
determine a variance between the current biometric state of the first user and the baseline biometric state of the first user; and
compare the variance to a threshold variance.

17. The system of claim 11, wherein the current biometric state of the first user indicates the first user is in a particular mood.

18. The system of claim 11, wherein the control circuitry is further configured to notify the second user that the second content control preferences have been selected based on the event.

19. The system of claim 11, wherein the control circuitry is further configured to:
determine that the current biometric state of the first user has become consistent with the baseline biometric state of the first user; and
in response to determining that the current biometric state of the first user has become consistent with the baseline biometric state of the first user, select the first content control preferences.

20. The system of claim 11, wherein the control circuitry is further configured to, in response to determining the current biometric state of the first user is inconsistent with the baseline biometric state of the first user, determine whether the current biometric state of the first user corresponds to a biometric state that affects first content control preferences.

21-50. (canceled)
